(19) United States
(12) Patent Application Publication
(10) Pub. No.: US 2004/0161563 A1
(43) Pub. Date: Aug. 19, 2004

(54) Slip collar for joining fume duct sections

(76) Inventor: Raymond L. Wellman, Vallejo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/368,028

(22) Filed: Feb. 19, 2003

(51) Int. Cl. B32B 1/08

(52) U.S. Cl. 428/36.91

(57) ABSTRACT

A slip collar for joining the ends of two duct section ends in an airtight, fire retardant joint which does not require an external clamping collar to provide structural strength and rigidity. A first embodiment of the collar includes concentric outer and inner walls joined by a toroidal seat attached to the inner surface of the outer wall which mates with a “U”-shaped cylindrical seat base attached to the outer surface of the inner wall. Separation between the walls determines two cylindrical slots which each closely receive an end portion of a duct section. A second embodiment, identical to the first embodiment, further includes a fluoropolymer film attached to the inner surface of the inner wall.

### BACKGROUND OF THE INVENTION

1. Field of the Invention

The present invention relates to fume exhaust duct connections for fiberglass reinforced plastic duct sections, and more particularly to a slip collar that enables duct section ends to be joined in an airtight, fire retardant joint which does not require an external clamping collar to provide structural strength and rigidity.

2. Description of the Related Art

Ductwork for corrosive vapor exhaust systems is used extensively in many diverse industries which utilize hazardous chemicals to process raw materials or perform manufacturing procedures, such as the semiconductor, plating, and pharmaceutical industries. Such ductwork also is required in the many research and development laboratories which use highly reactive, toxic or otherwise hazardous chemicals. Such chemicals not only can put workers at risk to hazardous fumes, but also are potential sources of contamination of industrial processes or laboratory experiments. Consequently, vapors from hazardous chemicals must be exhausted through leak-proof air ducts to safely remove them from work areas. Duct installations can be very large, consisting of many thousands of feet of ductwork which may be manifolded and connected to multiple exhaust fans. Because of the wide diversity of chemicals used in industrial and research applications, it is extremely difficult to provide a single material for fabricating ductwork which can withstand all the chemicals to which duct interiors may be exposed. Over the past forty years the trend in materials has been away from bare and coated metals and toward the use of plastics, particularly fiberglass reinforced plastics (FRP's) which incorporate various types of resins.

In addition to the problem of providing a duct capable of resisting broad classes of chemical vapors, there is also the problem of providing adequate resistance to fire. Unlike metallic ducts, plastic ducts exhausting chemicals which can react exothermically or with the duct interior surface are at risk to being set on fire. A problem common to all plastics has been flammability. Plastics can burn rapidly and produce toxic smoke, creating hazards of their own.

U.S. Pat. No. 5,298,299 to L. E. Shea, entitled “Double Wall Fireproof Duct”, which is incorporated in its entirety herein by reference, is directed to a dual-laminate tubular duct section having both good chemical resistance and good fire resistance. An inner laminate is formed by coating a mylar wrapped mandrel with a chemically resistant resin and then wrapping the mandrel with successive layers of FRP fabric saturated with the resin. An outer laminate is then formed directly over the inner laminate by applying successive layers of FRP fabric saturated with a fire-retardant resin.

U.S. Pat. No. 5,549,949 (“'949”) to D. Williams et al., entitled “Fume Duct Circumferential Joint Sealant”, which is incorporated in its entirety herein by reference, is directed to sealant compositions for sealing the circumferential joint between pairs of dual-laminate fume duct sections, and to a joint sealing method which provides strong bonding between the sealant and laminate surfaces which typically are phenolic/glass and vinyl ester. As discussed therein, ducts are fabricated as sections of standard length(s) which are transported to a job site and assembled there. Since a leak-proof joint is required between each pair of contiguous sections, even the smallest installation requires a considerable number of such joints. Joints must not only prevent fumes from escaping in day-to-day operation, but must also remain leakproof after prolonged exposure to corrosive or otherwise reactive chemicals. Also, joints must not fail catastrophically in the event a flame propagates through the interior or, if exposed directly to heat such as from a fire external to the ductwork, fail mechanically or become a source of smoke particulates and other contaminants. Because mechanical interfacing cannot by itself prevent leakage, a sealant must be applied circumferentially to each interface. The '949 patent provides a solution to simplifying what had been the most time-consuming step in joining dual-laminate sections, viz., preparing the resin-impregnated surfaces to which the sealant must bond in order to effect a leak-proof seal. Unless mating surfaces near the ends of each duct section were first sanded or otherwise polished, the interposing sealant layer would not uniformly adhere to the surfaces, resulting in porosities in the hardened sealant through which fumes could leak. These surfaces include the opposed end portions of the inner laminate surface, the opposed end portions of the outer laminate surface, and the exterior surfaces of a “slip” collar interposed internally between each pair of end sections.

Many installations require joints to have greater integrity to rupture from tensile and flexural loading than can be provided using only mechanical interfacing between the duct section ends and an internal slip collar, and sealant bonding. For example, ductwork disposed exterior to a building must be able to withstand flexure due to wind shear. Also, high velocity gases resulting from an explosive chemical reaction within a localized portion of a duct can create a large overpressure, stressing nearby joints even if the duct sections remain intact. The method disclosed in the '949 patent for reinforcing a joint is to form a “lay-up” bond by tightly winding alternate layers of fine boat cloth mesh and a combination of fiberglass sheeting and coarse woven roving mesh around the joint seam. The larger the duct diameter, the more layers must be used. Each time a dry layer is wound, it must be “wet out” with a resin component of the sealant. Lay-up reinforcement substantially strengthens the joint to the extent that under tensile loading the duct material is likely to rupture before the joint fails. While not as time-consuming as sanding, the lay-up method also entails considerable time and labor. Also, joints assembled according to the lay-up method are potentially susceptible to failure due to heating from flames interior or exterior to the ductwork. Even if a joint interior is not heated to a temperature high enough to cause the duct material to melt or burn through, the sealant can melt, burn or otherwise decompose to an extent that gases leak out. Similarly, if the joint exterior is heated, the sealant coating exterior mating surfaces can melt. At sufficiently high temperature, the lay-up wrapping can begin to burn, greatly reducing structural integrity and making the joint vulnerable to rupture from a normal flexural load. Consequently, there has existed a need for improved techniques for forming fire retardant joints which can withstand internal and external tensile and flexural loading.

A device for connecting together two FRP duct sections ends of equal diameter is disclosed in U.S. Pat. No. 5,505,497 (“'497”) to L. E. Shea et al., entitled “Mechanical Joint Connections for Fiberglass Reinforced Duct Sections”. The device includes two end gaskets each covering and setled to an end portion, a central gasket covering the two end gaskets and extending around both end portions, two spacer gaskets supporting a flexible metal sleeve surrounding the central gasket, and tightening devices on the sleeve which compress the central gasket and hold the aligned duct sections together. The tightening devices are spring-driven so that if the elastomeric gaskets are reduced due to fire, the sleeve will maintain a firm non-slip hold on the duct joint. The '497 device is not adapted for use with joints that incorporate an internal slip collar, and makes minimal use of sealant because FRP surfaces mate with gaskets rather than with other FRP surfaces. The sleeve acts to compress the gaskets and keep the duct sections aligned, but does not enhance structural integrity against tensile and flexural loads.

U.S. Pat. No. 5,961,154 (“'154”) discloses two embodiments of a clamping collar for strengthening the joint formed between two cylindrical dual-laminate duct sections joined by an internal, cylindrical FRP slip collar having a centrally disposed circumferential rib. In one embodiment the collar has two U-shaped clamp portions each having a metallic outer skin spot-welded to a metallic inner skin with protrusions which penetrate the duct section outer surfaces when the collar is tightened. The inner skins and slip collar are bonded to duct section surfaces using a putty-like sealant including a settable admixture of curing agent and novolac epoxy resin. In the other embodiment, preferred for duct sections 3-inches in diameter or smaller, the collar has a single circumferential clamp portion.

Compared to a joint formed using the '949 lay-up method, a joint formed using a '154 slip and clamping collars can be assembled in less time and will be structurally stronger and less susceptible to failure due to heating. A '154 joint also is superior to a '497 joint because the latter does not protect against loading. However, the several discontinuous operations required to form a '154 joint make assembly of ductwork not as efficient as can be achieved. The section ends, pre-coated with sealant, must first bc mated with the slip collar, and then more sealant applied to exterior surfaces. The sealant must be allowed to cure over several hours before the clamping collar is affixed so that the joint can be added to the overall structure. Ideally, assembly of a structurally strong joint should entail consecutive, time-and motion-efficient operations.

### OBJECTS OF THE INVENTION

In view of the foregoing, it is a primary object of the present invention to provide an improved slip collar for joining a pair of FRP fume duct tubular sections in a structurally strong, fire retardant joint.

Another object of the invention is to provide a slip collar which eliminates the need for an external clamping collar.

A further object of the invention is to provide a slip collar which can be manufactured over a range of sizes to accommodate tubular fume duct sections ranging in diameter from a few inches to several feet.

Yet another object of the invention is to provide a slip collar which allows forming a joint using a minimum number of consecutive operations and a minimum amount of sealant.

Other objects of the invention will become evident when the following description is considered with the accompanying drawings.

### SUMMARY OF THE INVENTION

These and other objects are met by the present invention which provides a slip collar including a cylindrical outer wall consisting essentially of a first material and having outer and inner surfaces. The inner surface is centrally attached to a toroidal seat consisting essentially of the same material. The slip collar further includes a cylindrical inner wall consisting essentially of a second material and having outer and inner surfaces. The outer surface is centrally attached to a cylindrical “U”-shaped seat base, consisting essentially of a third material, which has a recess determined by a base portion and opposed sidewalls. The seat is closely received within the recess and attached to the seat base. The separation between the outer and inner walls determines opposed, cylindrical slots adapted to closely receive an end portion of a duct section.

These and other features and advantages of the invention will become further apparent from the detailed description that follows, which is accompanied by drawing figures. In the figures and description, numerals indicate the various features of the invention, like numerals referring to like features throughout both the drawings and description.

### BRIEF DESCRIPTION OF THE DRAWINGS

FIG. 1 is a partially exploded perspective view of first and second embodiments of a slip collar for joining the ends of two fume duct sections, including an outer wall having a seat, and an inner wall having a seat base.

FIG. 1A is a detail view of region “1A” in FIG. 1 showing the seat closely received within the seat base.

FIG. 2 is a cross-sectional view of the FIG. 1 collar taken along lines 2-2.

FIG. 3A schematically depicts the first embodiment of the FIG. 1 collar wherein the outer wall and seat are fabricated from a first material, and the inner wall and seat base are fabricated from a second material.

FIG. 3B schematically depicts the second embodiment of the FIG. 1 collar wherein the outer wall and seat are fabricated from a first material, the inner wall and seat base are fabricated from a second material, and a fluoropolymer film is bonded to the inner surface of the inner wall.

### DESCRIPTION OF THE PREFERRED EMBODIMENTS

While the present invention is open to various modifications and alternative constructions, the preferred embodiments shown in the drawings will be described herein in detail. It is to be understood, however, there is no intention to limit the invention to the particular forms disclosed. On the contrary, it is intended that the invention cover all modifications, equivalences and alternative constructions falling within the spirit and scope of the invention as expressed in the appended claims.

Where used herein, the word “attached” means that the two parts referred to (e.g., the seat and seat base, or a duct section end portion and a surface of the collar outer wall) are either fabricated as a unitary piece by helically winding continuous strands of fiber filament ribbon, as described in Pub. No. 2002/0017333 A1, or bonded together. Where used herein, the word “connected” means that the two parts referred to (e.g., the collar outer wall and a duct section end portion) are mechanically joined, preferably by set screws.

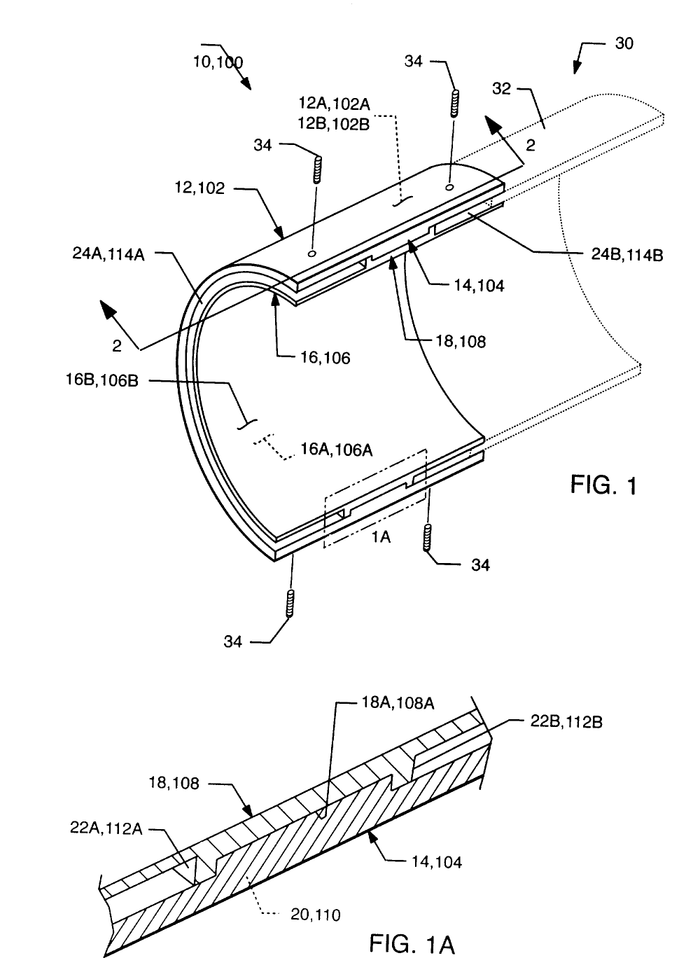

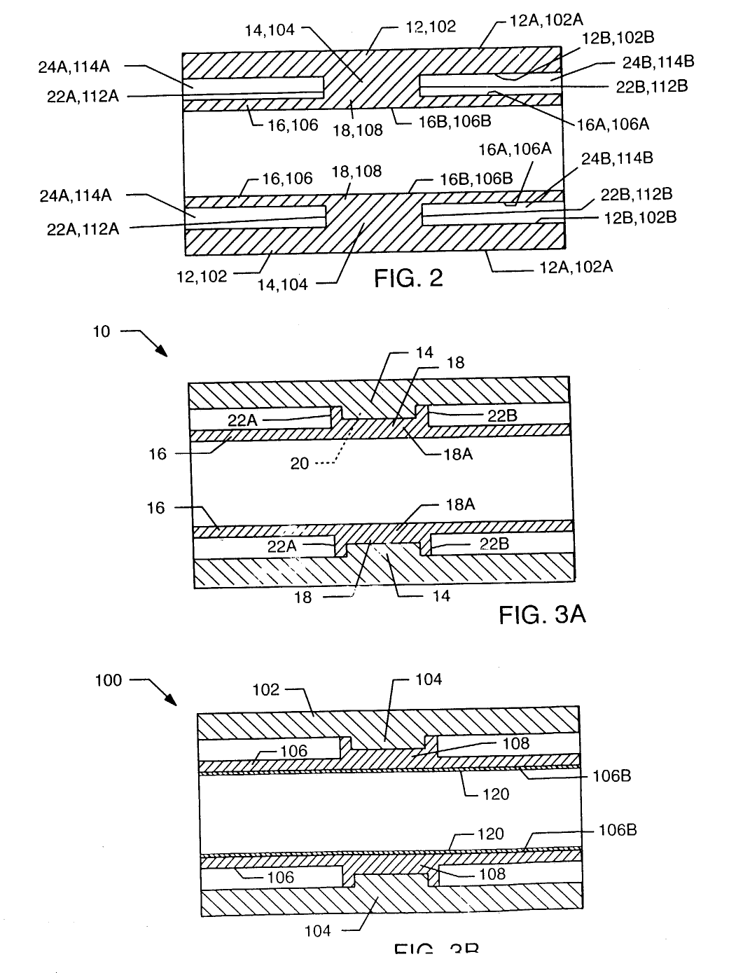

Referring to FIGS. 1, 1A and 2, in first and second embodiments according to the invention a slip collar 10, 100, respectively, includes a generally cylindrical outer wall 12, 102, respectively, having an outer surface 12A, 102A, respectively, and an inner surface 12B, 102B, respectively, to which is centrally attached a generally toroidal seat 14, 104 formed of the same material as the outer wall. Collars 10, 100 further include, respectively, a generally cylindrical inner wall 16, 106 having an inner surface 16B, 106B, respectively, and an outer surface 16A, 106A, respectively, to which is centrally attached, respectively, a generally cylindrical “U”-shaped seat base 18, 108 having a recess 20, 110, respectively, determined by a base portion 18A, 108A, respectively, and opposed first and second sidewalls 22A, 22B and 112A, 112B, respectively. Seat base 18, 108 closely receives and is attached to seat 14, 104, respectively. Preferably, seat base 18, 108 is formed of the same material as inner wall 16 106, respectively; alternatively, the inner wall and seat base may be formed of different materials. Outer and inner walls 12, 16 and 102, 106 determine, respectively, opposed and generally cylindrical first and second slots 24A, 24B and 114A, 114B, respectively. As indicated in FIG. 1 by phantom lines depicting the end portion of a duct section 30, each slot closely receives an end portion 32. The end portions are pre-coated with an adhesive sealant and connected to the outer wall by a plurality of set screws 34. Preferably, the sealant includes a settable admixture of curing agent and novolac epoxy resin.

FIG. 3A is a schematic representation of slip collar 10 with the inner wall 16 and seat base 18 formed of the same material. Wall 16, which serves as a corrosion barrier, is made from: (a) an admixture of a phenolic resin and catalyst; or (b) an admixture of a vinyl ester resin and catalyst; or (c) an admixture of an isophthallic resin (iso-resin) and catalyst. The thickness of wall 16 when made of phenolic resin is in a range from about 0.100- to about 0.200 inch, and preferably is about 0.150-inch. The thickness of wall 16 when made of vinyl ester or isophthallic resin is in a range from about 0.075- to about 0.100 inch, and preferably is about 0.100-inch. When made from a different material than wall 16, the seat base 18 is made from: (a) an admixture of fiberglass and resin; or (b) a non-corrodible metal such as galvanized iron or stainless steel. Depending on the internal pressure which the duct joint must withstand, the height of base 18, as determined by the thickness of base portion 18A and the height of sidewalls 22A, 22B, is in a range -from about 3/16- to about 1-inch. The depth of recess 20 is about one-half the height of base 18. The thickness of seat 14 equals the depth of recess 20. Outer wall 12 and seat 14 are made from: (a) an admixture of a phenolic resin and catalyst; or (b) an admixture of a vinyl ester resin and catalyst; or (c) a non-corrodible metal. The thickness of wall 12 is in a range from about 3/16-inch to about 1-½ inches.

FIG. 3B is a schematic representation of slip collar 100 with the inner wall 106 and seat base 108 formed of the same material. The choices of materials and ranges of thicknesses for outer wall 102, inner wall 106, seat 104 and seat base 108 are the same as those for wall 12, wall 16, seat 14 and base 108, respectively. Collar 100 differs from collar 10 in that attached to inner surface 106B of inner wall 106 is a fluoropolymer film 120. Compared to other polymers, fluoropolymers have outstanding resistance to chemical attack and remain stable at high temperature. But the physical properties that provide resistance and stability make them very difficult to adhere and bond to other materials. Preferably, the fluoropolymer used is ethylene-chlorotrifluoroethylene copolymer (ECTFE). ECTFE is a tough fluoropolyrner, resisting a wide variety of corrosive chemicals, organic solvents, strong acids, chlorine, and aqueous caustics. When ignited, ECTFE burns with low flame spread and smoke generation. U.S. Pat. No. 6,441,128 B1 to B. D. Bauman et al. discloses a process for fluoro-oxidation of ECTFE which modifies its surface properties so that the film can be adhesively bonded to polymeric and metallic surfaces. The film precursor can be compounded with carbon to provide an electrostatically dissipative liner. Other processes which can be used to provide a bonding surface to fluoropolymer films include plasma treatment, corona etching, and sodium etching. Fluoropolymer films which can be treated with these processes to provide a bondable film for use as a liner in the practice of the invention described herein can be fabricated from polytetrafluoroethylene (PTFE), fluorinated ethylene propylene resin (FEP), perfluoroalkoxy copolymer (PFA), polyvinylidene fluoride (PVDF) and the like. Preferably, the thickness of film 120 is in a range from about 0.001- to 0.010-inch. Most preferably, the film thickness is in a range from about 0.003- to about 0.005-inch.

What is claimed is:

1. A slip collar comprising:
a generally cylindrical outer wall consisting essentially of a first material and having outer and inner surfaces determining a preselected thickness, the inner surface centrally attached to a generally toroidal seat consisting essentially of said material and having a preselected thickness; and
a generally cylindrical inner wall consisting essentially of a second material and having outer and inner surfaces determining a preselected thickness, the outer surface centrally attached to a generally cylindrical “U”-shaped seat base consisting essentially of a third material and having a recess determined by a base portion having a preselected thickness and opposed first and second sidewalls having a preselected common height, the base portion and sidewalls determining the height of the seat base, the seat closely received within the recess and attached to the seat base, the outer and inner walls determining opposed, generally cylindrical first and second slots each adapted to closely receive an end portion of a duct section.

2. The slip collar of claim 1, further comprising a fluoropolymer film of a preselected thickness attached to the inner surface of the inner wall.

3. The slip collar of claim 2, wherein said film thickness is in a range from about 0.001-inch to about 0.010-inch.

4. The slip collar of claim 3, wherein said fluoropolymer is selected from the group consisting of ethylene-chlorotrifluoroethylene copolymer (ECTFE), polytetrafluoroethylene (PTFE), fluorinated ethylene propylene resin (FEP), perfluoroalkoxy copolymer (PFA) and polyvinylidene fluoride (PVDF).

5. The slip collar of claims 1 or 2, wherein said first material is selected from the group consisting of an admixture of a phenolic resin and catalyst, an admixture of a vinyl ester resin and catalyst, and a non-corrodible metal.

6. The slip collar of claim 5, wherein the outer wall thickness is in a range from about 3/16-inch to about 1-½ inches.

7. The slip collar of claims 1 or 2, wherein said second material is selected from the group consisting of an admixture of a vinyl ester resin and catalyst, and an admixture of an isophthallic resin and catalyst.

8. The slip collar of claim 7, wherein the inner wall thickness is in a range from about 0.075-inch to about 0.100-inch.

9. The slip collar of claims 1 or 2, wherein said second material is an admixture of a phenolic resin and catalyst.

10. The slip collar of claim 9, wherein the inner wall thickness is in a range from about 0.100-inch to about 0.200-inch.

11. The slip collar of claims 1 or 2, wherein said third material is selected from the group consisting of an admixture of fiberglass and resin, and a non-corrodible metal.

12. The slip collar of claim 11, wherein the height of the seat base is in a range from about 3/16-inch to about 1-inch.

13. The slip collar of claims 1 or 2, wherein the end portions of the duct sections received, respectively, within said first and second slots are coated with an adhesive sealant.

14. The slip collar of claim 13, wherein said sealant comprises a settable admixture of curing agent and novolac epoxy resin.
